(19) United States
(12) Patent Application Publication
(10) Pub. No.: US 2017/0210118 A1
(43) Pub. Date: Jul. 27, 2017

(54) DEVICE FOR HOT-FOIL STAMPING

(71) Applicant: HEIDELBERGER DRUCKMASCHINEN AG, Heidelberg (DE)

(72) Inventor: HANS SCHADL, HIRSCHAU (DE)

(21) Appl. No.: 15/412,113

(22) Filed: Jan. 23, 2017

(30) Foreign Application Priority Data
Jan. 22, 2016 (DE) 10 2016 000 662.5

(51) Int. Cl. B41F 16/00

(52) U.S. Cl. CPC B41F 16/0026

(57) ABSTRACT

A device for hot-foil stamping on printing materials includes a heated stamping cylinder, a counterpressure cylinder, and a device for providing stamping foil. The device for providing stamping foil guides the stamping foil between the stamping cylinder and the counterpressure cylinder in a direction tangential to the cylinders. The device for providing stamping foil has an adjustable guide element that is disposed downstream of the stamping cylinder and of the counterpressure cylinder for guiding the stamping foil. The hot-foil stamping device advantageously allows the stamping quality to be optimized.

### CROSS-REFERENCE TO RELATED APPLICATION

This application claims the priority, under 35 U.S.C. §119, of German Patent Application DE 10 2016 000 662.5, filed Jan. 22, 2016; the prior application is herewith incorporated by reference in its entirety.

### BACKGROUND OF THE INVENTION

### Field of the Invention

The invention relates to a device for hot-foil stamping on flat printing material including a heated stamping cylinder, a counterpressure cylinder, a device for transporting printing material, and a device for providing stamping foil. The device for providing stamping foil guides the stamping foil between the stamping cylinder and the counterpressure cylinder in a direction tangential to the cylinders.

The process known as hot-foil stamping is among the known enhancement processes of the printing industry.

In a hot-foil stamping process, smooth and shiny surface elements in metallic colors such as gold, silver, copper and aluminum may be transferred to the printing material. A carrier foil is coated with a coloring layer and a hot-melt glue (an adhesive layer). A heated stereotype plate or cliché (relief plate) is used to transfer the image under the influence of pressure and heat. Suitable machines are either rotary processing units in printing machines or flat-bed die-cutting and embossing machines. Hot-foil stamping is mainly used in various sheet and web products such as packaging for cosmetics, sweets and drinks as well as for high-quality brochures.

A rotary hot-foil stamping unit is described in German Patent Application DE 10 2009 019 590 A1 and illustrated in FIG. 8 thereof.

Adhesive forces are in effect in the stamping nip between the stamping cylinder and the counterpressure cylinder when the foil is removed from the printing material. Those adhesive forces have to be overcome in order to remove the foil after the stamping process. A difficulty in that context is that the stamped subject needs to keep its well-defined sharp edges and must not become frayed or blurred.

### SUMMARY OF THE INVENTION

It is accordingly an object of the invention to provide a device for hot-foil stamping, which overcomes the hereinafore-mentioned disadvantages of the heretofore-known devices of this general type and which allows the stamping quality to be optimized.

With the foregoing and other objects in view there is provided, in accordance with the invention, a device for hot-foil stamping on flat printing material. The device comprises a heated stamping cylinder and a counterpressure cylinder, a device for transporting the printing material and a device for providing a stamping foil. The printing material and the stamping foil define a removal angle therebetween. The device for providing the stamping foil guides the stamping foil between the stamping cylinder and the counterpressure cylinder in a direction tangential to the stamping cylinder and to the counterpressure cylinder. The device for providing the stamping foil includes at least one adjustable guide element for guiding the stamping foil. The at least one adjustable guide element is disposed downstream of the stamping cylinder and of the counterpressure cylinder, the at least one adjustable guide element has a position, and an adjustment of the position results in a modification of the removal angle.

The device of the invention is used for hot-foil stamping on sheet-shaped or web-shaped printing materials by using a heated stamping cylinder, a counterpressure cylinder interacting therewith, and a device for providing a stamping foil. The device for providing the stamping foil guides the stamping foil between the stamping cylinder and the counterpressure cylinder in a direction tangential to both cylinders, i.e. the foil does not wrap around the stamping cylinder or the counterpressure cylinder at all or only partly wraps around an angular section of the stamping cylinder or the counterpressure cylinder. In accordance with the invention, the device for providing a stamping foil has at least one adjustable guide element such as adjustable guide rolls or an adjustable guide roller, for guiding the stamping foil, the guide element is disposed downstream of and spaced apart from the stamping cylinder and the counterpressure cylinder. Thus the guide element might also be referred to as a deflecting element. For instance, one continuous guide roller or a number of guide rolls disposed next to one another on an axis of rotation may be used for this purpose. The guide element is disposed on the side of the device for providing a stamping foil relative to the plane of transport of the printing materials. Both are preferably disposed above the plane of transport of the printing materials. An adjustment unit is provided for adjustment purposes. This advantageously allows the contact time between the stamping foils and the printing material to be adjusted to optimize stamping quality. In accordance with a particularly advantageous further development, adjusting the position of the guide element causes the removal angle α between the printing material and the stamping foil to be modified.

In accordance with a particularly advantageous and thus preferred further development of the device of the invention, the guide element is disposed to pivot about an axis of rotation to carry out the adjustment movement. Alternatively, the guide element may be embodied to be movable along a linear axis, for instance in a horizontal, vertical, or transverse direction, to carry out the adjustment movement.

It is particularly advantageous if the device for providing a stamping foil has an actuator, in particular an electric motor such as a servomotor, to carry out the adjustment movement. Alternatively, a machine operator may make the adjustment by hand.

It is advantageous if a control unit is provided to actuate the actuator and if the control unit actuates the actuator for instance as a function of a processing speed. In accordance with an advantageous further development, job-dependent settings, i.e. settings in terms of the position of the guide element may be saved in a memory of the control unit to make them readily available in the case of a repeat job.

Speed-dependent guide element settings may likewise be saved and accessible in a memory of the control unit.

As far as it makes sense from a technical point of view, combinations of the invention as described above and of the advantageous further developments of the invention likewise form advantageous further developments of the invention.

Other features which are considered as characteristic for the invention are set forth in the appended claims.

Although the invention is illustrated and described herein as embodied in a device for hot-foil stamping, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIGS. 1a, 1b and 1c are diagrammatic, side-elevational views of a hot-foil stamping device of the invention with different foil removal angles;

FIG. 2 is a side-elevational view of an alternative hot-foil stamping device including a motor adjustment;

FIG. 3 is a side-elevational view of an alternative hot-foil stamping device including an alternative adjustment; and

FIG. 4 is a side-elevational view of alternative guide elements.

### DETAILED DESCRIPTION OF THE INVENTION

Referring now in detail to the figures of the drawing as a whole, there is seen a device 100 for hot-foil stamping, which is also referred to as a hot-foil stamper. The hot-foil stamper 100 includes a stamping cylinder 1 and a counterpressure cylinder 2 interacting therewith. A device 3 for providing a stamping foil 1001 guides the stamping foil 1001 through a stamping nip formed between the cylinders 1, 2. A printing material 1000 is likewise transported through the stamping nip between the cylinders 1, 2 in a direction of transport T. The printing material 1000 is guided in a direction tangential to the stamping cylinder 1 and the counterpressure cylinder 2, at least on the exit side of the stamping nip. Color and/or metal particles are transferred from the stamping foil 1001 to the printing material 1000 in the stamping nip. For this purpose, the stamping cylinder 1 may carry a (non-illustrated) stereotype or cliché and may have a (non-illustrated) heating element for heating the stereotype. The device 3 for providing the stamping foil 1001 includes an adjustment unit 10 for carrying out an adjustment movement v, v′, v″ of guide rolls 4 or a guide roller 4.

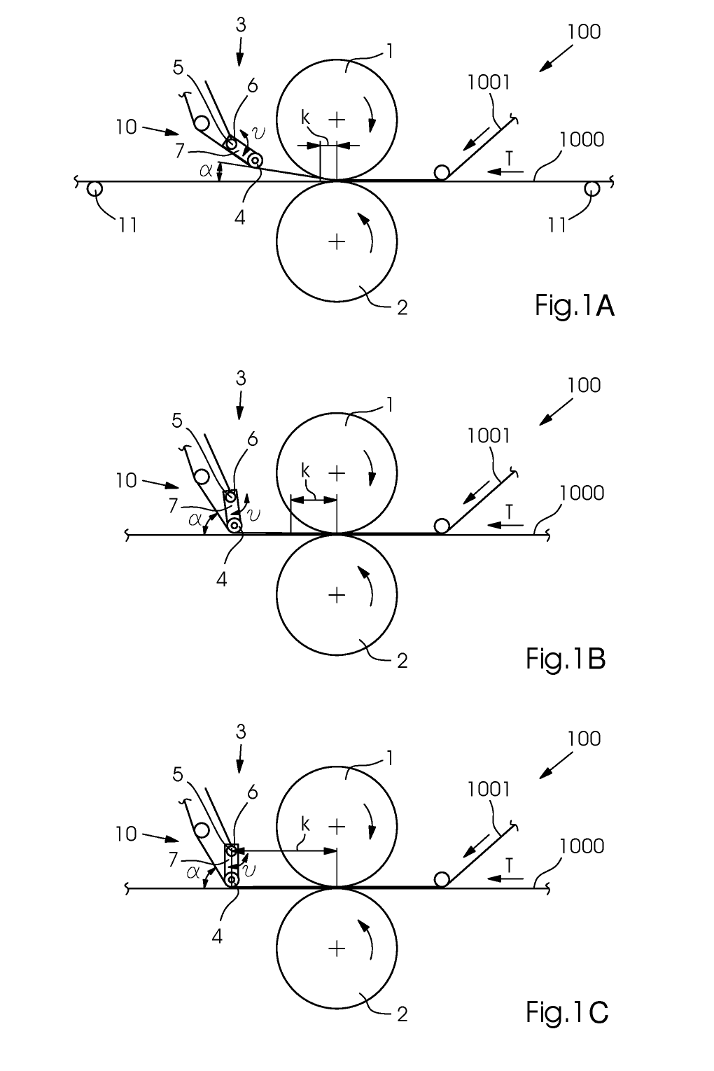

The device 3 for providing the stamping foil 1001 prescribes different removal angles α in FIGS. 1a, 1b, and 1c. The removal angle α is formed by the plane of transport of the printing material 1000 and the stamping foil 1001 running along guide rolls 4 or a guide roller 4 or a guide 4. The modification of the removal angle α is achieved by the fact that the stamping foil guide rolls 4 or guide roller 4 provided in the device 3 for providing the stamping foil 1001 pivot about an axis of rotation 5 with a lever embodied as a rotary arm 7 and by using a rotary shaft 6. The pivoting adjustment movement v modifies the position of the point of contact between the guide roll 4 or guide rollers 4 and the stamping foil 1001, thus changing the removal angle α and an area of contact k between the printing substrate 1000 and the stamping foil 1001. A modification of these parameters allows the stamping quality to be influenced and optimized.

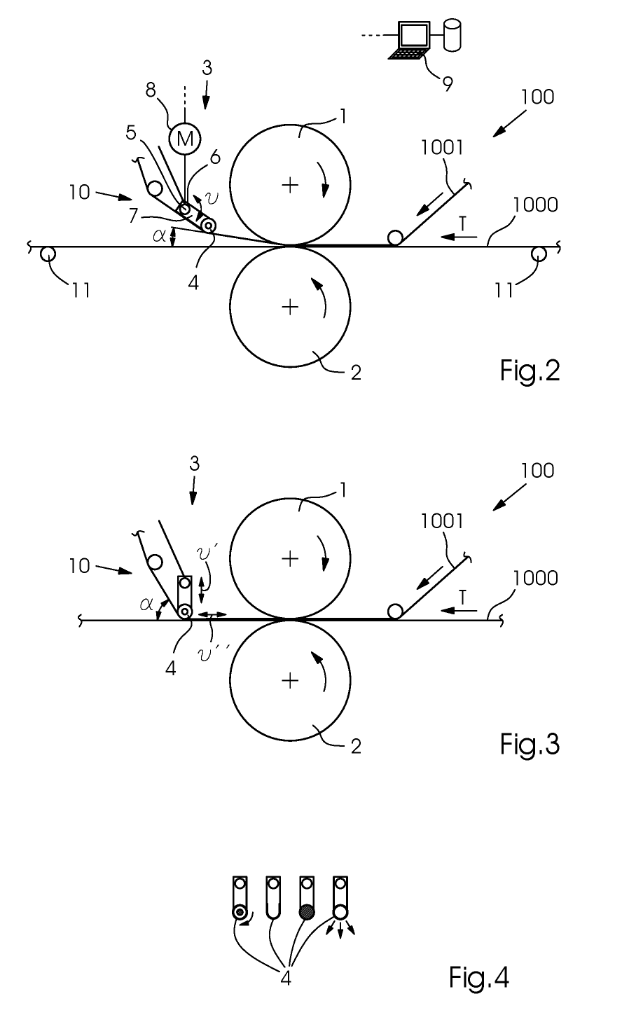

As is indicated in FIG. 2, the device 3 for providing the stamping foil 1001 of the hot-foil stamper 100 may include an electric motor 8 for driving the adjustment movement v of the guide rolls 4 or guide roller 4. The electric motor 8 is actuated by a control unit or controller 9 in which settings may be saved. FIG. 2 also indicates a device 11 for transporting printing material 1000.

The embodiment of the hot-foil stamper 100 shown in FIG. 3 includes a modified adjustment unit 10 and guide rolls or a guide roller 4. Rather than a pivoting movement v, a vertical adjustment movement v′ or a horizontal adjustment movement v″ of the guide rolls or guide roller 4 is envisaged.

FIG. 4 illustrates alternative embodiments of the guide element 4, that is the guide rolls or guide roller 4.

1. A device for hot-foil stamping on flat printing material, the device comprising:
a heated stamping cylinder and a counterpressure cylinder;
a device for transporting the printing material and a device for providing a stamping foil, the printing material and the stamping foil defining a removal angle therebetween;
said device for providing the stamping foil guiding the stamping foil between said stamping cylinder and said counterpressure cylinder in a direction tangential to said stamping cylinder and to said counterpressure cylinder, and said device for providing the stamping foil including at least one adjustable guide element for guiding the stamping foil; and
said at least one adjustable guide element being disposed downstream of said stamping cylinder and of said counterpressure cylinder, said at least one adjustable guide element having a position, and an adjustment of said position resulting in a modification of said removal angle.

2. The hot-foil stamping device according to claim 1, wherein said at least one adjustable guide element is pivotable about an axis of rotation.

3. The hot-foil stamping device according to claim 1, wherein said at least one adjustable guide element is movable along a linear axis.

4. The hot-foil stamping device according to claim 1, wherein said device for providing the stamping foil includes an actuator for carrying out the adjustment of said position of said at least one adjustable guide element.

5. The hot-foil stamping device according to claim 4, wherein said actuator is an electric motor.

6. The hot-foil stamping device according to claim 5, which further comprises a control unit for controlling said actuator.

7. The hot-foil stamping device according to claim 6, wherein said control unit has a memory for saving job-dependent settings of said at least one adjustable guide element.

8. The hot-foil stamping device according to claim 6, wherein said control unit has a memory for saving and accessing speed-dependent settings of said at least one adjustable guide element.

9. The hot-foil stamping device according to claim 1, wherein said at least one adjustable guide element is a guide roll, a guide roller, a round brush, a stationary profile part, a guide plate, a guide brush, a guide cushion or an air cushion roller.
